(19) United States
(12) Patent Application Publication
(10) Pub. No.: US 2005/0112030 A1
(43) Pub. Date: May 26, 2005

(54) Meshwell plates

(76) Inventor: Stephanie E. Gaus, (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/923,253

(22) Filed: Aug. 20, 2004

Related U.S. Application Data
(60) Provisional application No. 60/497,459, filed on Aug. 21, 2003.

(51) Int. Cl. B01L 3/00

(52) U.S. Cl. 422/101

(57) ABSTRACT

A versatile mesh-bottom Meshwell plate enables simultaneous rapid and highly reproducible high-throughput processing of small tissue samples or organisms. In an embodiment, the Meshwell plate consists of 96 meshwells and is particularly useful in assaying zebrafish embryos. The bottom tips of standard 96-well PCR plates are removed and replaced by a mesh with openings of about 75-300 μm, preferably 150 μm, in size. The Meshwell plate is optimized to allow fast draining of solutions and to prevent “wicking” of solution between wells. Quick and clean changes of solution can be done either by hand or a robot. With the Meshwell plate, waste of reagent solution and handling hazards, which may cause damage to and/or loss of samples, are substantially minimized and/or essentially eliminated. The Meshwell plate can be easily customized according to number of meshwells desired and can be economically mass-produced.

### CROSS-REFERENCES TO RELATED APPLICATIONS

This application claims the benefit from a provisional Patent Application No. 60/497,459, filed Aug. 21, 2003, which is incorporated herein by reference in its entirety.

### STATEMENT REGARDING FEDERALLY SPONSORED RESEARCH OR DEVELOPMENT

This invention was supported in part by the National Institutes of Health (NIH), grant No. NS23724. The U.S. Government may have certain rights in this invention.

### BACKGROUND OF THE INVENTION

1. Field of the Invention

This invention relates generally to well plates. More particularly, it relates to meshwell plates and method of making the same, the meshwell plates being useful for high throughput applications of assaying tissue/small organisms in small volumes of liquids.

2. Description of the Related Art

Many different types of wells with meshes or filters at the bottom are currently available for use in various tissue processing/culturing applications, e.g., polystyrene inserts fitted with polyester mesh bottoms for use in 6 and 12 well-plates. The meshes or filters at the bottom of the wells function as carriers and/or strainers for multicellular, relatively large organisms and tissue samples. Thus, the sizes of these wells are generally large. FIG. 1 shows prior art Netwell® products by Corning, which are typically pre-loaded in well cluster plates for purchase. Each well cluster plate contains either six 24 mm (diameter) or twelve 15 mm netwells. Each individual netwell is fitted with a 74 μm or 500 μm membrane mesh bottom. As shown in FIG. 1, specially designed Netwell® carriers and handles are needed for simultaneous processing of up to 12 samples/specimens per carrier.

Understandably, using these large individual netwells to process small organisms/tissue samples can be very inefficient, tedious, and wasting reagent/solution. Consequently, laboratory investigators would try to fabricate small individual holders and/or tubes to process small organisms/tissue samples such as developing zebrafish (Danio rerio). For example, Monte Westerfield teaches in “The Zebrafish Book”, University of Oregon Press, edition 4, 2000, page 8.8, how to use BEEM® capsules to make small holders that would be suitable for processing zebrafish embryos. BEEM® is a registered trademark of Better Equipment for Electron Microscopy, Inc. As FIG. 2 illustrates, a small individual zebrafish embryo holder is painstakingly made by cutting off the bottom end of a capsule, covering the open bottom with a circle of mesh cut from silk organza or Dacron® (available from Du Pont), and then securing the mesh in place with dental floss. Another small well (not shown) is used as a solution-containing well for each individual holder. The solution-containing well might have a volume of 2-3 ml. However, with the individual holder and specimen, only about 0.5 to 1.0 ml volume of solution could be placed inside. Each individual holder is then transferred from one solution-containing well to the next, draining the mesh bottom of the holder briefly in between.

There are several drawbacks related to these small individual holders. First, although several holders may be processed in the same reagent tray by using a petri dish as the solution-containing plate, no carriers are currently available for holding and transferring multiple holders at a time. Therefore, multiple holders processed together in “single well” reagent trays would still have to be transferred individually from one tray to the next, and risk of specimen loss from tipped-over or mixed-up tubes may be substantial. Second, the holders themselves can be difficult to make and maintain. The dental floss can break or slide off. Moreover, specimens can get lost and/or damaged by getting trapped below the holder wall or between the mesh and the outside of the holder wall. Finally, the well size of the holder is still larger than what is necessary for processing small samples such as zebrafish embryos.

On the other hand, there are several styles of filter-bottom well plates available. As one skilled in the art would appreciate, mesh-bottom wells are distinguishable from filter-bottom well plates. Mesh-bottom wells are useful in processing tissue samples/small organisms, while finer membrane- or filter-bottom well plates are typically used in cell culture/assays, biochemical assays (including bead conjugates), and nucleic acid purification.

FIG. 3A shows an example of a filter-bottom well plate, UniCell™ 24 microplate, by Whaan. UniCell™ 24 microplate is a multiwell microplate for cell culture screening and analysis and consists of a 24-well filtration microplate containing a polycarbonate membrane with a pore size of 0.4 μm, a 24-well feeder tray with round wells having a volume of 3.5 ml, and a polystyrene lid cover. The polycarbonate membrane allows the formation of a confluent monolayer of mammalian cells and the harvesting of cells either by sloughing or by mechanical removal of the membrane. The growth chamber, contained in the top filtered microplate, sits inside the feeder tray. The clearance between the bottom of the membrane and the bottom of the feeder tray is 2 mm, i.e., the filter bottoms do not touch the bottom of the tray. Each well is completely sealed and sits in its own, individual feeder well, as shown in FIG. 3B.

The UniCell™ 24 microplate is specially designed for applications in permeability studies, co-cultivation, tissue resistance, cell migration, and toxicology and is not suitable for assaying small organisms such as zebrafish embryos. It is not ideal for immunohistochemistry. Firstly, the aforementioned 2 mm clearance is essentially a dead space, which is a waste of valuable reagent. Secondly, this dead space causes problems when the specimens need to be kept gently moving on an orbital shaker. This is because the dead space effectively increases the vertical dimension of the liquid volume. As such, the shaker must spin very fast to make the specimens move, which could shred or otherwise damage the specimens. Thirdly, and more importantly, because the UniCell™ 24 microplates have very fine filters, the filter bottoms of the UniCell™ 24 microplates retain water. A vacuum is needed to drain out solutions, which is cumbersome, hard to keep clean/RNase free, and time consuming.

In summary, while many filter-bottom well plates are available, few styles of mesh-bottom plates exist, and none are ideally suited for assaying tissue/small organisms such as zebrafish embryos in small volumes of liquids. Therefore, what is needed in the art is a mesh-bottom well plate that would enable efficient, high-throughput applications of a large number of small volume (up to 500 μl) organisms/tissue assays, including in-situ hybridization and immunohistochemistry paradigms.

### SUMMARY OF THE INVENTION

The present invention fulfills this need in the art by providing an inventive and versatile mesh-bottom well plate, hereinafter referred to as the Meshwell™ plate and methods of making and using the same. The Meshwell plate enables simultaneous rapid and highly reproducible high-throughput processing of small tissue samples or organisms.

In a preferred embodiment, the Meshwell plate consists of 96 meshwells, enables simultaneous processing of up to 96 small samples, and is particularly useful in assaying zebrafish embryos. The bottom tips of standard 96-well PCR plates are removed and replaced by a mesh with openings of about 75-300 μm, preferably 150 μm, in size.

The Meshwell plate may be perforated to allow customization of number of meshwells. The Meshwell plate is optimized to allow fast draining of solutions and to prevent “wicking” of solution between wells. Quick and clean changes of solution can be done either by hand or a robot. With the Meshwell plate, waste of reagent solution and handling hazards, which may cause damage to and/or loss of samples, are substantially minimized and/or essentially eliminated. The Meshwell plate can be easily customized according to number of meshwells desired and can be economically mass-produced.

Other objects and advantages of the present invention will become apparent to one skilled in the art upon reading and understanding the preferred embodiments described below with reference to the following drawings.

### BRIEF DESCRIPTION OF THE DRAWINGS

FIG. 1 shows prior art large individual mesh-bottom wells with specially designed carriers and handles.

FIG. 2 shows a prior art small individual mesh-bottom well and steps of making the same.

FIGS. 3A-3B show a prior art filter-bottom well plate having a polycarbonate membrane specifically designed for cell culture applications.

FIGS. 4A-4B show an embodiment of the Meshwell plate in FIG. 4A and a portion thereof in FIG. 4B.

FIG. 5 schematically illustrates a side view of an embodiment of the Meshwell plate in use with a 96-well plate functioning as a solution tray.

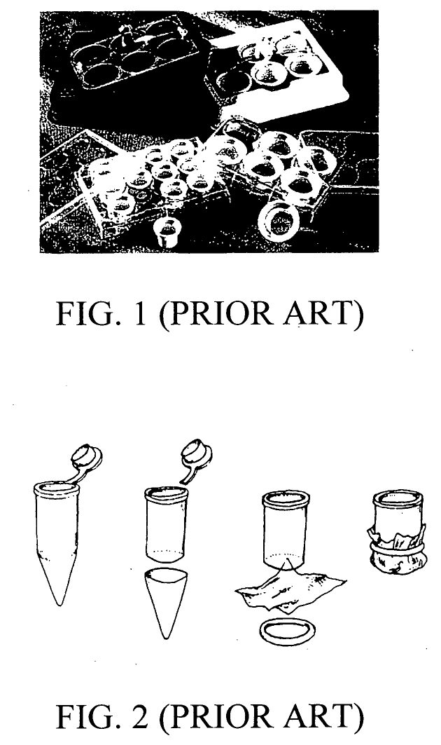

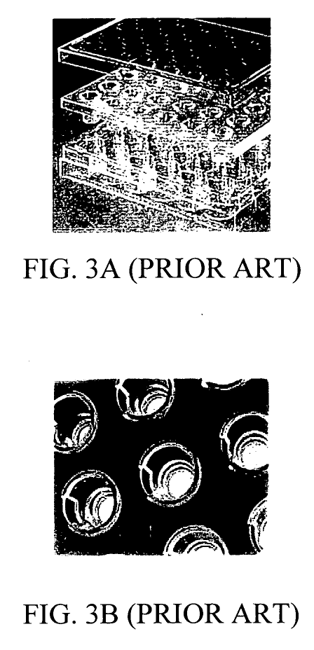

### DETAILED DESCRIPTION OF THE PREFERRED EMBODIMENTS

Several techniques are currently used by laboratory investigators to process tissue samples. One technique involves the use of forceps to transfer the specimens from one solution to another. Because forceps may damage the specimens, this is not a desired technique.

Another technique, known as the centrifuge tube technique, requires pipetting one solution onto the specimens in a centrifuge tube and then aspirating it off, which may cause some loss of specimens. Specifically, for each step, each individual tube must be picked up, opened, one solution aspirated off carefully to maximize solution removal while minimizing damage/loss of tissue/organisms, another solution added, and the tube must be closed and finally put down again.

To process a large number of small organisms/tissue samples, such technique is not only tedious and inefficient, but also error prone and slow. Even assuming an investigator can work fast enough to spend an average of 5 seconds per tube to change one solution, which is extremely difficult if not impossible to maintain, 96 tubes would take 8 minutes of work, longer than some of the wash-times in common protocols, e.g., multiple 5-minute incubation washes. Consequently, the protocol would have to be changed and the experiment would take even longer.

As discussed before with reference to FIG. 2, some laboratory investigators use small individual mesh-bottom wells (holders) to process small organisms/tissue samples to avoid the tedious transfer of individual small samples. However, each individual holder must be painstakingly made and only a small number of individual holders can be processed at a time.

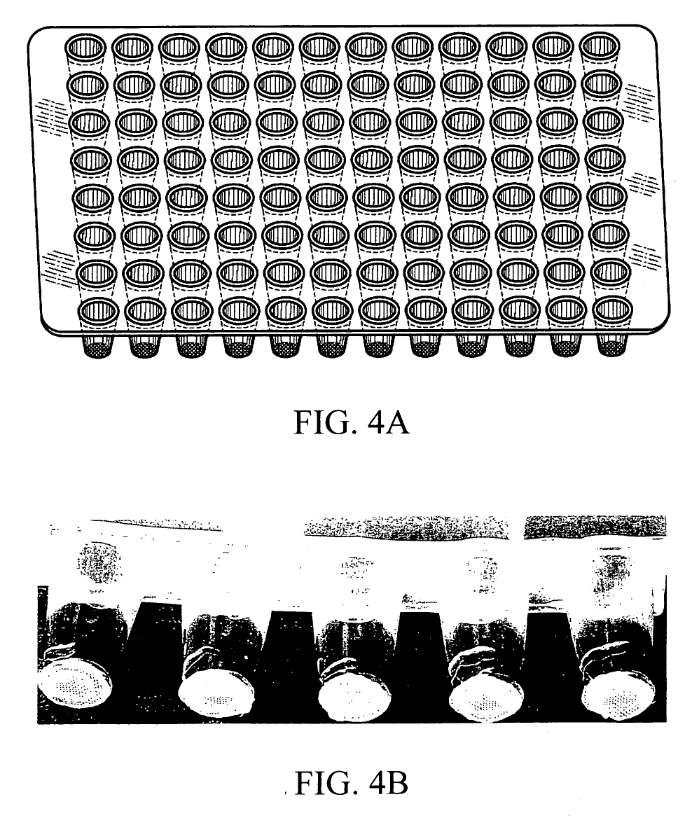

The Meshwell plate disclosed herein is particularly designed and made to address the need of an ideal mesh-bottom well plate suitable for processing a large number of small organisms/tissue samples. FIG. 4A is a photograph of a 96-meshwell plate successfully made and used by the inventor. FIG. 4B is a close-up view of five actual meshwells, each having a mesh bottom selectively designed for allowing drainage of aqueous solutions without requiring a vacuum or any sucking means. These meshwells were part of another 96-meshwell plate also successfully made and used by the inventor.

The Meshwell plate can be made of any commercially available well plate and preferably made of a flat-topped PCR 96-well plate of 12 mm in depth. The bottoms of the wells are first cut off, using a hot wire or any suitable means, approximately 3 mm and sealed off with a plastic netting or mesh, e.g. Nitex, with mesh opening of, preferably, 150 μm. As can be seen from FIG. 4, the size of the meshwells (I.D. and O.D. ca. 6 mm) is smaller than that of a centrifuge tube (I.D. ca. 10 mm, O.D. ca. 11 mm). Note the walls of the meshwells are extremely thin.

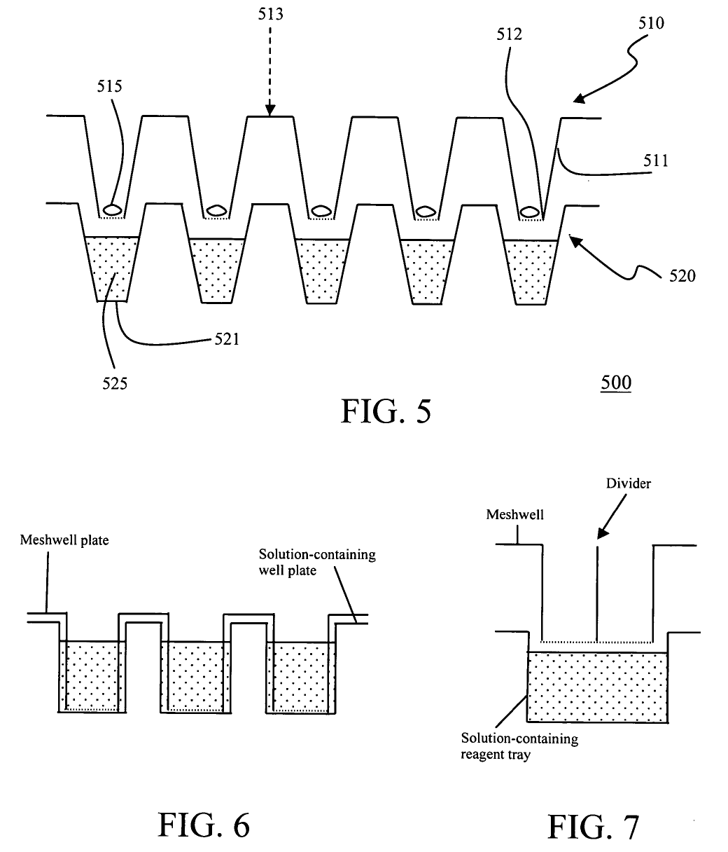

FIG. 5 illustrates an exemplary embodiment of a Meshwell plate system (kit) 500. The system 500 includes a monolithic Meshwell plate 510 having a plurality of meshwells 511. Each well bottom of the meshwells 511 is sealed off with a mesh 512, preferably with an opening size of 150 μm. The Meshwell plate 510 is preferably a 96-meshwell plate. To allow the number of meshwells be customized based on application, in some embodiments, the Meshwell plate 510 is made of a material such as plastic that is thin enough to be easily cut with scissors into strips or blocks. In addition, the Meshwell plate 510 may be perforated, e.g., along line 513. Alternatively, it can be made as a single-piece 6-, 12-, 24-, or 48-Meshwell plate, with or without perforation, in which case, the inner/outer diameters (I.D./O.D.) could be, respectively 35 mm, 22 mm, 15 mm, 10 mm, and 6 mm.

The system 500 includes an optional solution-containing well plate 520 having a plurality of solution-containing wells 521 that correspond to meshwells 511. The solution-containing wells 521 may have an I.D. of 36 mm, 23 mm, 16 mm, 11 mm, or 7 mm, depending on the size of the meshwells 511. To process small samples 515, e.g., 2-mm long zebrafish embryos, in meshwells 511, wells 521 may contain solutions 525, which can be tailored according to application.

In an embodiment, the solution-containing well plate 520 is a commercially available, semi-translucent, extra-large-well 96-well plate having I.D. of 8 mm and round bottoms. However, it will be understood by one skilled in the art that the meshwells can be made to fit in any standard well plate with the appropriate number of wells. Such a standard well plate may be made of clear plastic and have flat bottom wells. The bottoms of meshwells 511 should touch the bottoms of solution-containing wells 521. Each well 521 holds 500 μl maximum per well, in which case, the meshwells 511 function well with about 200-400 μl solution per well.

Alternatively, a single well plate or reagent tray (not shown) can be used in place of the well plate 520. When used with a one-well solution-containing plate, the shapes and sizes and number of the meshwells can desirably vary according to needs and applications. For example, the meshwells can be rectangular-shaped which would allow for a more efficient use of space within the solution-containing plate. The system 500 may optionally include a lid (not shown) and/or a gel sheet (not shown) such as those discussed below.

Although both meshwells 511 and solution-containing wells 521 are shown in FIG. 5 as sloping concentrically, it is preferred to have 10 mm deep flat-bottom clear wells, and have sides of the meshwells be completely vertical. Also, the optional lid preferably should have slightly longer sides than those typically found on standard lids for 96-well plates, since the Meshwell plate is raised a couple mm above the surface of the solution-containing plate.

According to an aspect of the invention, simultaneous assaying of up to 96 small organisms/tissue samples can be realized with the Meshwell plate. In an exemplary embodiment, 2-mm long zebrafish embryos are placed in the meshwells. The Meshwell plate is then placed into consecutive solutions: each solution quickly drains out as the Meshwell plate is lifted out of the solution. Each time the zebrafish embryos are immersed in new solution as the Meshwell plate is moved to the next solution-containing plate. During assay incubations, the Meshwell plate can be covered with a commercially-available plastic lid. For long or high-temperature incubations, a snug gel sheet, also commercially available, can be used to fit tightly cover the meshwells to avoid solution concentration changes due to evaporation or condensation.

As discussed herein, the meshwells are useful in many applications including, but not limited to, immunohistochemistry and in situ hybridization. Moreover, the Meshwell plate of the present invention can be used for any assay when simultaneous manipulation of a large number of tissue samples is needed. In particular, it can advantageously replace the tedious, slow, error prone centrifuge-tube technique for zebrafish embryo screening. Using the Meshwell plate, the inventor has successfully performed in situ hybridization on zebrafish embryos/fry up to day 21 of development.

In an exemplary embodiment, a Meshwell plate is made according to the following steps:

(1) Flatten a 96-well flat-topped PCR plate to remove slight curvature, if necessary. This can be done by using hot water/cold treaent while the plate is sandwiched between two flat pieces of material. If the 96-well plate is not flat-topped, the tops of the wells may have to be cut off.

(2) Cut off the bottom few mm, e.g., about 3 mm, of the wells. This can be accomplished by sliding the plate, bottom-up, in a hood, along a fixed straight electric “hot wire” which cuts the plastic by melting it. The cut-off “caps”, which may re-anneal to the plastic plate as they fall off, may be removed with mini needle-nose pliers.

(3) Apply a sheet of Nitex netting to the bottom of the 96-well plate. This can be done by melting the just-cut bottom surface of the 96-well plate onto a hotplate (on high setting, in a hood) for a second, then immediately pressing it onto a sheet of Nitex laying on a cool, flat surface (e.g., metal surface of hood below sash). Because the pressure on the 96-well plate must be even when pressing onto the hotplate and the Nitex, and to protect your fingers from the hotplate, securing/taping the 96-well plate to a flat metal block (e.g., from a drybath) to use as a handle/press would be helpful. The plastic will harden in a couple of seconds and affix the netting more securely to the plastic well bottoms. This adhesion method produces a bond stronger than by super-gluing the netting onto the well bottoms. The mesh opening of the netting should be large enough to allow all solutions to drain easily, even 70% glycerol. In this example, mesh opening of 150 μm is used.

(4) Remove excess netting from between the wells. This can be accomplished by using a soldering iron (fine point tip, use in a hood) to instantly melt/burn away Nitex. Care must be used not to accidentally melt through one of the plastic wells, thus creating a hole. If a hole is created, it can be patched with melted plastic on the tip of the soldering iron. Care should also be taken not to burn a hole in the netting on any of the meshwells themselves, and not to leave much/any netting around each meshwell, which could impair solution drainage or create overflow problems during the assay. A swift circle drawn around each meshwell with the soldering iron tip, cleaned on a wet sponge after each circle, may work best.

(5) Depending on number of meshwells desired, the Meshwell plate can optionally be cut into strips, blocks, or single meshwells, which can be done using any appropriate means such as scissors, hot wire, soldering iron, or even by hand, if perforated. Perforation can be utilized to facilitate the customization of number of meshwells desired. Again, care should be exercised not to make holes in the individual meshwells. If visibility is a concern, use white paper or a flat-panel light underneath to enhance visibility of the meshwells. The Meshwell plate can also be placed on a shaker and at temperature of choice; it floats easily in water bath. However, be sure that the flotation of the Meshwell plate is supported so it does not dip into the water.

The present invention offers many advantages and improvements over existing wells and well plates. For example, the Meshwell plate successfully replaced the centrifuge tube technique for in situ hybridization. In addition, the Meshwell plate can be used for immunohistochemistry as well as other screening applications and for a variety of small organisms and tissues, including drosophila, xenopus eggs, mouse tissue, genotyping mouse tails, etc.

As one skilled in the art would appreciate, risk of dropping individual holders/tubes and risk of forgetting which individual holders/tubes received which solution changes (especially when the investigator's concentration is interrupted) increase with number of individual holders/tubes and number of solution changes. Moreover, prior art well plates require repetitive motion for both hands, producing enormous strain and risk of repetitive stress injury.

With the Meshwell plate, each change of solution (for up to 96 experiments) is dramatically simplified. Lifting a lid, if using, transferring the Meshwell plate to a different pre-filled solution-containing well plate (or to different solutions on the same plate, if using e.g., a strip of meshwells such as one shown in FIG. 4B), and replacing the lid, if applicable, would take only about 5 seconds or less. Solution-containing plates can be pre-filled at the beginning of the day—or even at the beginning of the multi-day experiment—in a few minutes using multi-channel repeating pipettors (or even by simply pouring solution into, e.g., a single-well plate), and stored (covered) at the appropriate temperature. This advantageously eliminates the tedious pipetting of individual holders/tubes required in the prior art example. Mistakes due to interruption and/or forgetfulness can be eliminated or otherwise substantially minimized by numbering or labeling the solution-containing plates and/or rows of each solution-containing plate to correspond to each step of the assay.

What is more, efficiency of solution change is greatly improved because all meshwells would drain solution simultaneously. For the same reason, consistency is maintained among experiments because all meshwells would receive solution changes simultaneously. While preventing “wicking” of solutions between meshwells, one can still “wick” solution out of the meshwells, for example, by dragging the bottom of the meshwells along the inside of the solution-containing wells as the meshwells are removed from the solution. Alternatively, wicking can be done by touching the meshwell bottoms to the flat top surface of the solution-containing plate for one to two seconds, right after lifting the Meshwell plate out of the solution. The ability to prevent wicking of solutions between meshwells is desirable when the solutions are to be isolated from each other. The ability to wick solution out of the meshwells is desirable because it enhances drainage. Wicking is generally unnecessary if pore size is large enough.

The superiority of the Meshwell plate over prior art tubes, wells, well plates, and the like is illustrated in the following examples.

With individual centrifuge tubes, the fresh solution is diluted into the older solution left behind in each tube, surrounding the sample and a thin layer on top. Where small volumes of solutions are re-used over several experiments, as in costly probe hybridization solutions or antibody solutions, the effect of such dilution can be significant over time. With the Meshwell plate, barely any solution and only a thin film covering the sample is carried over from one solution change to the next. Also, it takes less time to change the solutions so the specimens do not dry out in between solution changes. In the particular zebrafish embryo application mentioned heretofore, it has been shown that zebrafish embryo egg sacs, which disintegrate when exposed to air, remain nicely intact during solution changes in the 96-Meshwell plate, even after wicking.

Centrifuge tubes generally require individual tube labeling, which takes time and can lead to mix-ups and mistakes. The tubes take up more physical space, which could be problematic for large screening applications. Importantly, using centrifuge tubes, the laboratory investigator risks damaging or even losing embryos/tissues during each solution aspiration, which is a lot of risk compounded over 96 experiments times about 50 solution changes for a typical 3-day in situ protocol, which equals about 4800 aspirations. Note the time involved in centrifuge tube protocols is typically 96 experiments times 50 solution changes times at least 5 seconds per change. The total comes to almost seven hours of continuous, repetitive, time-wasting, risky, tiring solution-changing. With the 96-Meshwell plate, the total solution changes would only take five minutes or less. The time- and fatigue-saving factors also apply to smaller batches of experiments, e.g., 15 experiments with tubes would take over an hour of solution changes. With multiple 96-Meshwell plates, these savings can be dramatically increased as the size of experiments increases.

Compared to individual mesh-bottom wells such as the Netwell products by Corning, the Meshwell plates (1) are in one piece, significantly saving time, organization, and frustration with small individual parts, (2) can be conveniently and easily customized per application, e.g., cut or broken into smaller pieces including strips, blocks, or individual meshwells, thereby saving time, space, and material, (3) are available in much smaller sizes, e.g., with 24 or more meshwells, thus would be particularly useful for processing small tissue samples/organisms, (4) could be available RNase-free for in situ experiments, etc., (5) are anticipated to be substantially less expensive because of one-piece construction and the use of commonly available plates, 96-well plates, storage plates, micro-plates, etc. as solution-containing plates, (6) can be used for high-throughput screens, including robotic screens, and (7) have reduced dead space when used with a standard solution-containing plate.

Compared to filter-bottom well plates, the Meshwell plates (1) have different well-diameter: the filter-bottom well plates often have little if any room around the sides of each well for liquid to freely flow, creating problems with fluid overflow, (2) have different depth: the filter-bottom well plates, by design, do not extend far enough down into the underlying solution to permit adequate coverage/washing of any organisms/tissue samples, leading to overflow problems if one attempts to increase the solution volume for adequate coverage of the samples, (3) have different mesh opening size: the pore sizes of the membrane used for the filter-bottom well plates are too small to allow easy gravity drainage even with wicking, (4) can be customized, as discussed above, according to number of meshwells needed, and (5) do not require the use of forceps, vacuum, wicking, and the like.

Compared to in-situ robotic or automated systems, the Meshwell plates (1) are significantly less expensive, (2) easier to use and maintain because no programming skills are required, (3) would not have the risk of failed experiments due to clogging (which is a problem with the robot) because the membrane pore size is larger, and in any case, the user would see immediately upon solution change if there were a drainage problem and could fix it, rather than finding out the next day or so that something had gone wrong, (4) allow any incubations at any temperature, as desired, whereas the robot only allows one solution to be heated, with no option for refrigeration (as antibody solutions generally are), (5) allow incubations to be placed on rotators, if desired, (6) can be used in many applications, not just in situ hybridization, (7) allow multiple 96 experiments be performed with minimal time, expense and space, instead of one set of 96 experiments at a time, (8) save labspace, (9) in some cases, would be faster because no protocol changes would be needed for e.g., wash time—where the current robot would take 20 minutes to complete one full set of solution changes, the Meshwell plate would take only about five seconds or less, (10) may save expensive/precious probe in cases where protocols require adding extra probe throughout the probe incubation, (11) can be easily adapted for use with existing high-throughput robots, and (12) are more flexible, e.g., if color development needs to be checked/extended, it can be easily done without reprogramming the robot.

As it will be appreciated by one of ordinary skill in the art, the above embodiments may be implemented in many ways and various changes, substitutions, and alternations can be made without departing from the principles and the scope of the present invention. For example, the Meshwell plates and solution-containing plates could be made of re-usable/disposable materials. Preferably, the Meshwell plate is made of polystyrene or rigid polypropylene so it lies completely flat on the surface of the solution-containing plate and does not curve up in the center or edges, as some PCR well plates tend to do. Large-volume washes can be performed by using solution plates of 2 ml/well capacity (for a 96-Meshwell plate) and the like, or by placing the Meshwell plate into a single reservoir of user-determined capacity, or even flowing washes. The 96-Meshwell plate can be easily integrated into robotics.

As discussed herein, the Meshwell plates can be cut into strips or single meshwells for economically, conveniently, simultaneously running any number of experiments, while maintaining consistent, identical conditions as a large-scale screen. The Meshwell plates could be perforated, e.g., in strips or squares, and/or made of material that can be easily cut into strips or squares. Moreover, at least in the 96-Meshwell plates, the meshwells are small narrow wells with large mesh openings and sufficient depth, allowing easy drainage of solutions as well as submersion into a great solution volume without overflowing reagents in the solution-containing plate. The Meshwell plates are particularly useful for economical, efficient, high throughput applications of a large number of small volume organisms/tissue assays, including in-situ hybridization and immunohistochemistry paradigms.

One skilled in the art will also appreciate that the present invention can be readily implemented to include one-well and square format Meshwell plates, which are well suited in cases where specimens are larger than what would ideally fit in a well of a 6-well plate. For example, large sections of fixed human brain tissue are used in pathology labs for post-mortem identification of neurological disease such as Alzheimer's disease. In these cases, a 1-well plate would be helpful. This “μl-Meshwell plate” would be rectangular and would fit inside a standard, commercially-available one-well solution-containing plate (with lid). The bottom mesh should be strong enough to pick up wet sections, have a mesh opening large enough for solution to drain (but not allow specimens to fall out), and be attached strongly enough to the sides of the well so the mesh would not separate from the sides, creating a hole through which specimens could slide out. Nylon membrane may be an appropriate material. Other plastics may be used, as well as fine stainless steel meshes, which may work better for this application.

Sometimes, it is important to the investigator that the specimens/solution in each meshwell be gently moved, e.g., by placing the plate on an orbital shaker, during an incubation. In general, the larger the surface area of the solution, and the more shallow the volume of solution, the more easily the solution is swirled. To get solutions in a 96-well solution containing plate to swirl visibly, they need to be rotated quickly around a small radius. Special high-speed shakers are available for this purpose; however, this is generally used in assays (e.g., ELISAs) without a meshwell-plate or the like. If fragile eggs or organisms were to be rotated at such speeds, they might be damaged or destroyed. Therefore, placing the meshwell plate in a one-well solution-containing plate, and rotating it gently (e.g., at 55 rpm) will achieve the desired effect.

The design of the 1-meshwell plate could be adapted to yield, e.g., a 2-Meshwell plate, with a divider, which the mesh also adheres to, positioned in the middle or wherever desired. Alternatively, a 4-, 6-, 8-, and so on Meshwell plate can be made in this “square-well” format. These plates would have the advantage of more volume per well than a well in their respective counterpart standard plate. Plates with 12-, 24-, 48-, 96- or more meshwells arranged in this “square-well” format are also possible, each of which would also fit into a one-well solution-containing plate, and each of which would offer more volume per well than in round meshwell plates. The square-well format in a one-well solution-containing plate would allow a more efficient use of space within the solution-containing plate. Therefore, for protocols requiring various specimens to have identical exposure to reagents (i.e., can use a one-well solution-containing plate), Meshwell plates with square-well formats might be advantageous.

Although the present invention and its advantages have been described in detail, it should be understood that the present invention is not limited to or defined by what is shown or described herein. Rather, the scope of the present invention should be determined by the following claims and their legal equivalents.

1. A Meshwell plate system comprising:
a Meshwell plate having one or more meshwells for processing a plurality of small organisms or tissue samples; and
a solution-containing reagent tray or well plate having one or more solution-containing wells, wherein
each well bottom of said meshwells is sealed off with a mesh that allows drainage of aqueous solutions without requiring a vacuum or any sucking means, and wherein
said well bottom of said one or more meshwells touches a well bottom of said one or more solution-containing wells.

2. The Meshwell plate system according to claim 1, wherein
said Meshwell plate is a 6-, 12-, 24-, 48-, or 96-meshwell plate.

3. The Meshwell plate system according to claim 1, wherein
said mesh has an opening size of about 75 μm to about 300 μm.

4. The Meshwell plate system according to claim 1, wherein
said mesh has an opening size of 150 μm.

5. The Meshwell plate system according to claim 1, wherein
said Meshwell plate is perforated in groups or individually.

6. The Meshwell plate system according to claim 1, wherein
said one or more meshwells have a cylindrical, conical, or rectangular shape.

7. The Meshwell plate system according to claim 1, further comprising:
a divider adhered to said mesh for dividing said Meshwell plate having a single meshwell.

8. The Meshwell plate system according to claim 7, wherein
said single meshwell is square or rectangular.

9. The Meshwell plate system according to claim 1, wherein
said Meshwell plate has 96 meshwells, each of which has an outer diameter of 6 mm; and wherein
said solution-containing reagent tray or well plate has 96 solution-containing wells, each of which has an inner diameter of 8 mm.

10. The Meshwell plate system according to claim 1, wherein
said solution-containing wells are 10 mm deep.

11. The Meshwell plate system according to claim 1, wherein
said one or more meshwells have vertical sides that raise said Meshwell plate above surface of said solution-containing reagent tray or well plate.

12. The Meshwell plate system according to claim 7, wherein
each of said solution-containing wells holds up to 500 μl solution; and wherein
each of said meshwells holds about 200-400 μl solution.

13. The Meshwell plate system according to claim 7, further comprising:
a lid for covering said Meshwell plate over said solution-containing well plate.

14. A method of making a Meshwell plate, comprising the steps of:
removing well bottoms of a PCR plate, thereby producing wells with open bottoms;
melting said open bottoms by applying said PCR plate with even pressure onto a hot flat surface for about a second;
applying said open bottoms with even pressure onto a mesh material laying on a cool flat surface such that said mesh material anneals onto said open bottoms, said mesh material allowing drainage of aqueous solutions without requiring a vacuum or any sucking means; and
removing excess mesh material from between said wells, thereby producing meshwells suitable for simultaneously processing a plurality of small organisms or tissue samples.

15. The method according to claim 14, comprising the step of:
flattening said PCR plate.

16. The method according to claim 14, further comprising the steps of:
sliding said PCR plate, bottom-up, in a hood, along a straight electrical hot wire; and
removing cut-off caps that are re-annealed to said well bottoms.

17. The method according to claim 14, further comprising the steps of:
securing said PCR plate to a body having a flat surface.

18. The method according to claim 14, comprising the steps of:
using a soldering iron with a fine point tip to instantly melt or burn away said excess mesh material.

19. The method according to claim 14, comprising the steps of:
dividing said meshwells into strips, blocks, or individual meshwells.

20. A Meshwell plate produced according to the steps of claim 14, wherein
said mesh material is made of nylon, plastic or stainless steel, and wherein
said mesh material has an opening size of 75 μm, 300 μm, or therebetween.
